(19) United States
(12) Patent Application Publication
(10) Pub. No.: US 2011/0311328 A1
(43) Pub. Date: Dec. 22, 2011

(54) Locating Device for Use with Power Tools

(76) Inventors: William Alexander Barr, Earlysville, VA (US); Deborah Fulton Barr, Earlyville, VA (US); William Harrison Fulton, White Slamon, WA (US)

(21) Appl. No.: 13/165,746

(22) Filed: Jun. 21, 2011

Related U.S. Application Data
(60) Provisional application No. 61/356,860, filed on Jun. 21, 2010.

(51) Int. Cl. B23B 49/00; B23B 47/00

(52) U.S. Cl. 408/2; 408/16

(57) ABSTRACT

A powered cutting tool for locating objects behind sheet material and subsequently cutting around the object. The tool incorporates at least one sensor having a transceiver emitting signal to detect at least one from the group of object density, conductivity, depth, and identification. The sensor is housed within a sensor unit that is affixed to the body of the cutting tool. The sensor unit can be integral with, or removable from, the cutting tool. A marking unit is used to mark the cutting area of the sheet material and is generally integral with, or located near, a sensor unit. Indicator members, such as lights, audio, and/or display screen, are used to provide information to the user.

### FIELD OF THE INVENTION

The invention relates to a sensor that is integral or easily attachable to a power tool for the purpose of enabling the power tool to both locate blind objects behind a covering surface and perform its usual function.

### BACKGROUND OF THE INVENTION

In construction, it is common to need to locate a hidden object such as a beam or a stud behind a wall as part of the construction process. Location sensors, commonly referred to as ‘stud finders’, have been developed to accomplish this purpose. In normal operation, stud finders are used to locate a hidden beam or stud and the area is then marked with a pencil or other marking device. Although this is not so much of an issue when looking for studs within a wall, this method becomes more difficult when, for example, searching for the location of light fixtures within a ceiling.

Wiring and other components for electrical, networking or other such systems in a residential or commercial structure are installed prior to applying the sheet material, such as drywall. Although much can be done prior to application of the sheet material, some items, such as ceiling fixtures and outlet/switch boxes are typically cutout after positioning and tacking the sheet material in place. These installations require the removal of a portion of the sheet material just outside the boundaries of the fixtures and electric boxes.

The problems encountered in the removal of the wall covering for a wall outlet or switch are surmountable, but time-consuming and require modest effort using existing technologies. The more difficult task arises when installing ceiling light fixtures. This user is required to work overhead while standing on a ladder, scaffolding, stilts, or similar equipment. In order to cut out the drywall from the proper location, one of two possible procedures is used. The most common way is for the user to measure from the walls to the center of the installed fixture before hanging the drywall sheet. Once the sheet is tacked in place, the user re-measures and marks to locate the position of the center of the fixture behind the drywall, penetrates the drywall placing the bit at the marked location and cuts laterally until the bit stops on the edge of the fixture. The bit is then withdrawn and inserted through to the outside of the fixture's edge. Using the edge as a guide, the drywall inside the fixture is cut out by routing in a counter-clockwise motion. In an alternate fashion, the user measures and marks the precise location of the fixture on the to-be-installed sheet of drywall and cuts out the area using those markings. Either way it is a time-consuming and frustrating task, requiring the use of both of the user's hands and two additional tools (i.e. a tape measure and marking instrument). Other methods are known in the trade, however all of them require switching tools while standing on a ladder, scaffolding, etc.

The safety problems associated with the prior methods as well as the additional time and effort expended has been resolved by using the disclosed invention that incorporates a sensor for locating objects behind sheet material with various cutting tools, eg. drywall routers (also known as spiral saws) as well as reciprocating and oscillating saws.

### Description of the Invention

### BRIEF DESCRIPTION OF THE DRAWINGS

FIG. 1 is a side view of a drywall router having an integral sensor positioned at the operational end, in accordance with the invention;

FIG. 2 is a front view of the router of FIG. 1 in accordance with the invention;

FIG. 3 is a side view of an alternate embodiment having a trigger and sensor unit and marker placed toward the base of the cutting tool, in accordance with the invention;

FIG. 4 is a side view of the drywall router having an integral sensor on the end of a flexible arm, in accordance with the invention;

FIG. 5 is a front view of the drywall router of FIG. 4, in accordance with the invention;

FIG. 6 is a side view of the drywall router having an integral and affixed sensor/marker located in the handle in accordance with the invention;

FIG. 7 is a side view of a drywall router having an integral and telescoping sensor in the extended position in accordance with the invention;

FIG. 8 is a cut away side view of an example of the telescoping sensor of FIG. 7 in accordance with the invention;

FIG. 9 is a side view of a sensor unit, having a marking unit, on a flexible arm and movable around the body of the router in accordance with the invention;

FIG. 10A is a back view of a drywall router having an affixed sensor/marker incorporated into the bottom of the router in accordance with the invention;

FIG. 10B is a side view of the router of FIG. 10A in accordance with the invention;

FIG. 11 is a side view of a drywall router having a removable sensing unit in accordance with the invention;

FIG. 12 is a side view of a router having an extendable sensor marking unit in accordance with the invention;

FIG. 13 is a front view of the sensing unit of FIG. 12 in accordance with the invention;

FIG. 14 is a side view of a router having a sensor recessed into the top of the router in accordance with the invention;

FIG. 15 is a side view of a router, having a removable, plug-in sensor in accordance with the invention,

FIG. 16 is a side view of an alternate sensor unit design for use with the slide of FIG. 12 in accordance with the invention.

FIG. 17 is a cut away side view of an alternate having a trigger and cavity to receive a pivotal sensor and marking unit in accordance with the invention;

FIG. 18 is a side view of an alternate embodiment having a handle with a trigger at right angles to the router body in accordance with the invention.

FIG. 19 is an additional embodiment in accordance with the invention.

### DETAILED DESCRIPTION OF THE INVENTION

Drywall routers, also known as spiral saws, are commonly used by tradesmen for cutting openings in drywall in order to expose electrical switch boxes, outlet boxes, heating and air conditioning vents, as well as a myriad of other cutting operations. Typically these small handheld units are designed to be operated in a freehand manner to penetrate drywall and to cut an opening for utilities hidden behind it.

One of the more common uses for these routers is the cutting out of drywall which is covering installed ceiling light fixtures. This requires the user to work overhead while standing on a ladder, scaffolding, stilts, or similar equipment. In order to cut out the drywall from the proper location, one of two possible procedures is used. The most common way is for the user to measure from the walls to the center of the installed fixture before hanging the drywall sheet. Once the sheet is tacked in place, the user re-measures and marks to locate the position of the center of the fixture on the drywall surface, penetrates the drywall placing the bit at the marked location, and cuts laterally until the bit stops on the edge of the fixture. The bit is then withdrawn and inserted through to the outside of the fixture's edge. Using the edge as a guide, the drywall inside the fixture is cut out by routing in a counter-clockwise motion. In an alternate fashion, the user measures the fixture location and transfers those measurements by marking the precise location of the fixture on the to-be-installed sheet of drywall. Cutouts are then made using those markings. Either way it is a time-consuming task requiring the use of both the user's hands and two additional tools (i.e. a tape measure and marking instrument). Other methods are known in the trade, however all of them require switching tools while standing on a ladder, scaffolding, etc.

In using other tools, such as drills and reciprocating saws, a similar need is apparent where the measuring and locating task requires additional actions from the drilling/cutting operation itself.

The disclosed sensor is, in one embodiment, integral to the tool and in an alternate embodiment as an attachment to the tool.

### Definitions

As used herein the term “marking device” shall refer to any device that will transmit a mark to sheet material. This includes a punch, ink, pencil or any other device that will leave a mark indicating a location.

As used herein the term “sensor” or “detector” shall refer to a device, including all required electronics and equipment, capable of detecting an object behind sheet material. Examples of items to be detected are recessed lighting fixtures, electric boxes, studs, rebar, live wiring etc., which are manufactured from various materials such as metal, wood and plastic.

As used herein the term “sensor unit” or “detector unit” includes the sensor(s) with accompanying electronics and the sensor(s) housing or casing, protecting the sensor. In removable embodiments, the sensor unit will also include the electrical connectors and means of attaching the sensor unit to the tool. A sensor unit can contain one or more sensors. The design of the sensor housing is, in of itself, not critical as long as the flat outer surface of the sensor and the marking device clears the tool body during use. Generally the housing will consist of the flat outer surface with sides, top and bottom configured to the body of the tool. Sensors can be of any type, as well known in the art at present and that may become available in the future. Sensors include object density sensors, electrical wiring sensors, including capacitance, impedance, amperage and electric field proximity sensors, and magnetic field sensors. It is well known to use changes in capacitance to sense where the stud is. When the plate inside the stud finder is over wall board, it will sense one dielectric constant (sort of like an insulating value); but when it is over a stud, the dielectric constant is different. It works on a capacitance differential generated by density difference. The circuit in the stud finder can sense the change and reports it. The latest technology in stud finders uses a very small radar system to detect the stud.

As used herein the term “power source” shall refer to any means from which a tool receives power, for example solar, battery, or regular alternating current. When power sources other than alternating current are used, the applicable solar panels, battery packs, etc. that are required will be evident to those skilled in the art.

As used herein the term “trigger” shall refer to any device, switch, button, etc. that can be placed in two or more positions to activate one or more features on the tool. The trigger can, therefore, be used to activate both the router and the sensor either individually or in tandem.

As used herein the term “router”, “drywall router” and “spiral saw” are all used herein interchangeably.

As used herein the term “cutting tool” refers to any hand tool having a bit or blade that can be used to cut sheet material, including but not limited to reciprocating, spiral, and oscillating saws.

As used herein the term “sheet material” shall refer to any material that covers the walls and/or ceilings of a structure. Drywall, wallboard, gypsum board and plasterboard are common terms for sheet material for covering walls and ceiling.

As used herein the term “transceiver”, “receiver” and “transmitter” refer to any electronics consisting of one or more units that can transmit and read the transmitted signal upon its return.

In any of the disclosed embodiments the trigger operating the router and the sensor, can be combined or separate. When the router and sensor controls are combined, examples of the operation are as follows:

The trigger has two positions with the first position being off and the second position activating either 1) the detector or 2) the router depending on the positioning of a separate selector switch located on the tool.

A three position trigger is off in the first position and activates the detector in the second position. By pulling the trigger further to the third position, the router is activated. In position 3, the detector could be deactivated or not.

With a four position trigger the power is off in the first position and the detector activated in the second position. By pulling the trigger further to the third position, the router is activated and the detector is deactivated. By pulling the trigger even further to the fourth position, both the router and the detector are activated.

The cutting tool can also have a switch that controls the activation of the router or detector similar to the switches on drills that change the direction of the drill from forward to reverse. Other combinations will be evident to those skilled in the art.

The sensor units herein are illustrated in some embodiments as integral with marking devices and in other embodiments separate from marking devices. It should be noted that the determination as to which embodiment to use is based upon manufacturing decisions and not functionality. Preferably the sensors units in all embodiments have the ability to control the strength of the signal as well as differentiate between various materials, such as wood, plastic, live wires, etc. By controlling the strength of the signal, the depth of location can be controlled. This is advantageous in that the device can be set to locate only items of applicability. For example, the depth could be set to only react to a two (2) inch depth, thereby detecting the edge of a recessed lighting fixture and ignoring any wiring to the back of the fixture. An example of the sensor's ability to detect live wires and metal is sold as the Zircon Corporation MultiScanner i520. The technology used in metal detectors, preferably with discrimination, very low frequency, pulse induction or beat-frequency oscillation can also be used in one or more sensors.

Similar to standard stud finders, the sensor unit used in the disclosed device can have easily visible indicator LED lights that indicate that the sensor is operable, when the object has been found, and when live wires have been detected. The indicator LEDs can be on the body of the tool or on the sensor unit.

Audio alerts, having multiple sounds with a separate distinct sound for live wires, can be incorporated into any of the embodiments indicating that the object has been detected. This serves as an additional safety feature in the event the user is not paying attention to the LED indicating the live wire.

The use of the metal detector technology, including the screen, distance indicator, visual display etc., as disclosed in embodiments herein, can be incorporated in any of the disclosed embodiments in whole or in part. Additionally, a microprocessor can be incorporated to enable programming of desired densities, depth, indicators, etc. through either use of a USB port or control panel.

The above technologies can also be combined as multiple sensors in a single sensor unit or multiple sensor units.

Although the drawings and description are predominately directed to a spiral saw, or router, it should be noted that any cutting tool with a body can incorporate the disclosed technology and design modifications will be obvious to those skilled in the art.

The sensors that are incorporated in cutting tools without triggers can be activated through a switch, trigger or button on the sensor or at some location convenient for manufacture on the tool.

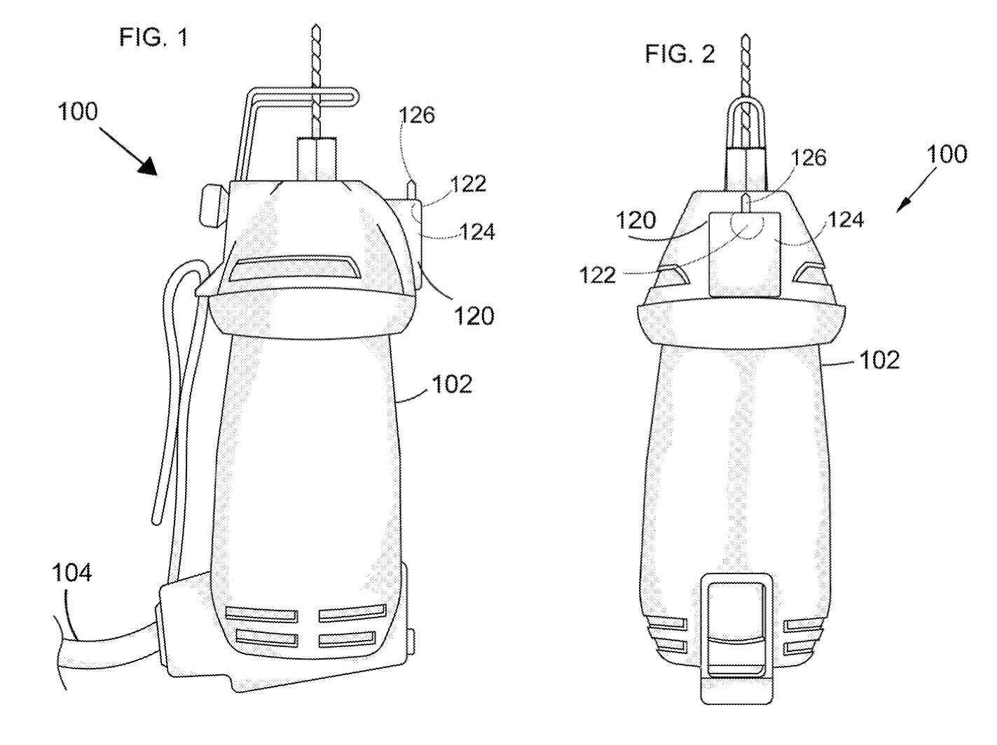

In FIGS. 1-2 the sensor unit 120 is adjacent to the body 102 of the router 100. In some router designs, a portion of the sensor electronics can be recessed to whatever extent possible without interfering with the router operation. The sensor unit 120 must extend a sufficient distance from the body 102 to permit the sensor unit surface 124 to clear any protrusions on the router body 102, in order to come in contact with the sheet material. In this embodiment the sensor unit 120 is integral with the body 102, formed at time of manufacture. The extent to which the sensor unit 124 extends from the body 102 will be dependent upon the tool, size of sensing device and type of securing method and will be evident to those skilled in the art. The placement of the sensor 122 within the sensor unit 120, as well as transmitting and receiving technology, is dependent upon the type of sensor being used.

The marking device 126 in this embodiment is positioned at the top of the sensor unit 120. The placement of the marking device 126 must be such that it is free to contact the sheet material without portions of the tool obstructing contact. The marking device 126 must also be positioned to avoid any blockage of the transmitting/receiving signal from the transceiver. Although dependent upon the tool, it is preferable that only a tilting of the sensor unit 120 in the range of ten (10) to fifteen (15) degrees would bring the marking device 126 in contact with the sheet material.

It should be noted that the marking device 126 is not mandatory to the functioning of the sensor unit 120 and can be eliminated if desired.

To use the router 100, the tool is rotated to place the sensor unit surface 124 adjacent to the sheet material and activate the sensor. As known in the art, the sensor needs to receive a baseline reading from the covering surface with no hidden object behind and is then slid across the covering surface until alerted with the discovered target, at which point one uses the marking end to push and mark the spot. Once an object is found, the router 100 is tilted to bring the marking device 126 in contact with the sheet material. This is repeated as many times as needed to adequately mark the periphery.

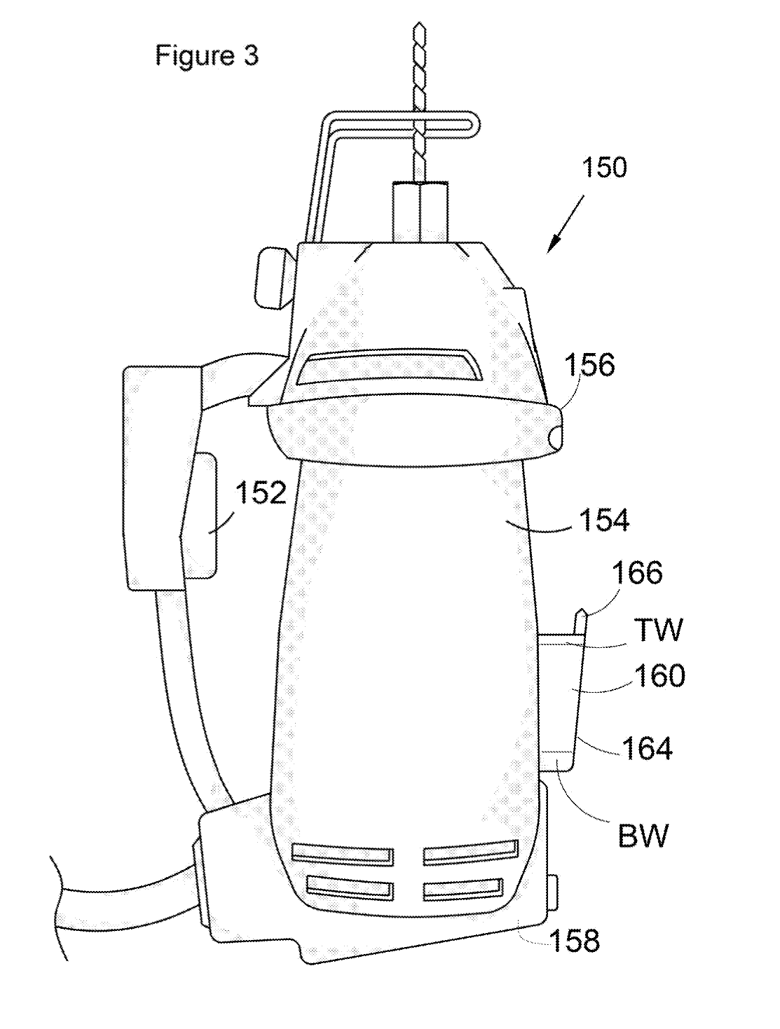

FIG. 3 illustrates a router 150 that has a handle and uses a variable or multi-speed trigger 152 to operate the router 150. In this embodiment the sensor 160 is located on the bottom portion of the side of the body 154, toward the base. The sensor unit 160 must have a top width TW to extend beyond the collar 156 of the body 154 to enable a clear access path to the drywall. The contact surface 164 of the sensor unit 160 is angled to ensure that the marker 166 can contact the sheet material without interference from the body 154 of the router 150.

The length of the marker can be about 3/32 inches, although the location will affect the length. The criteria are that the marker has sufficient length to contact the sheet material, does not interfere with the flat outside surface of the sensor unit, and leaves an indicating mark. The indicating mark can be left by a sharpened point making an indentation, by ink or pencil that would fit into a holder or by other means that would be obvious to one skilled in the art.

The marker 166 extends from the sensor unit 160 a sufficient amount to mark the sheet material. Depending upon the width TW, the marker 166 could require a slight angle in order to enable it to contact the sheet material without interference from the body 154.

To enable contact with the sheet material, the bottom width BW of the sensor unit 160 must be sufficient to clear the base 158. Due to the angle of the contact surface 164, the bottom width BW does not need to extend away from the body 154 a sufficient amount to clear the collar 156. The angle of the contact surface 164 as well as the top width TW and bottom width BW can vary depending upon the tool being used and these variations will be obvious to those skilled in the art.

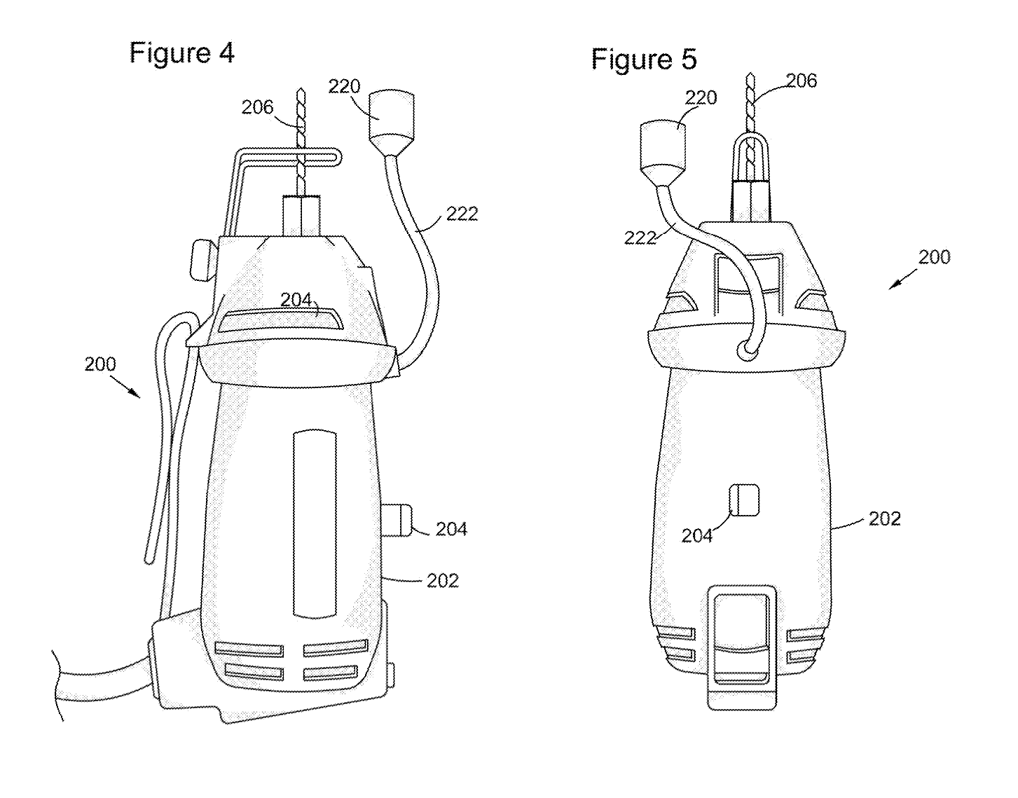

FIGS. 4 and 5 illustrate an alternate embodiment of the router 200 wherein the sensor unit 220 is attached to a flexible arm 222 that extends from the body 202 The body 202 can be provided with an arm holder 204 dimensioned to receive the flexible arm 222 and prevent its movement unless removed from the holder 204. The holder 204 can be any means convenient for manufacture such as dual prongs, a U-shape with an open side, hook and loop material, etc. The flexible arm 222 enables the sensor unit 220 to be positioned in relationship to the bit 206, thereby enabling the user to not only estimate the distance from the light or other fixture to the bit 206, but maintain the sensor unit 220 adjacent to the surface being cut during use. As with the prior embodiment, the sensor unit 220 is connected directly to the router 200's power source.

The flexible arms of FIGS. 4 and 5 are good embodiments for cutting tools that are not as conducive to the embodiments of FIGS. 1-3.

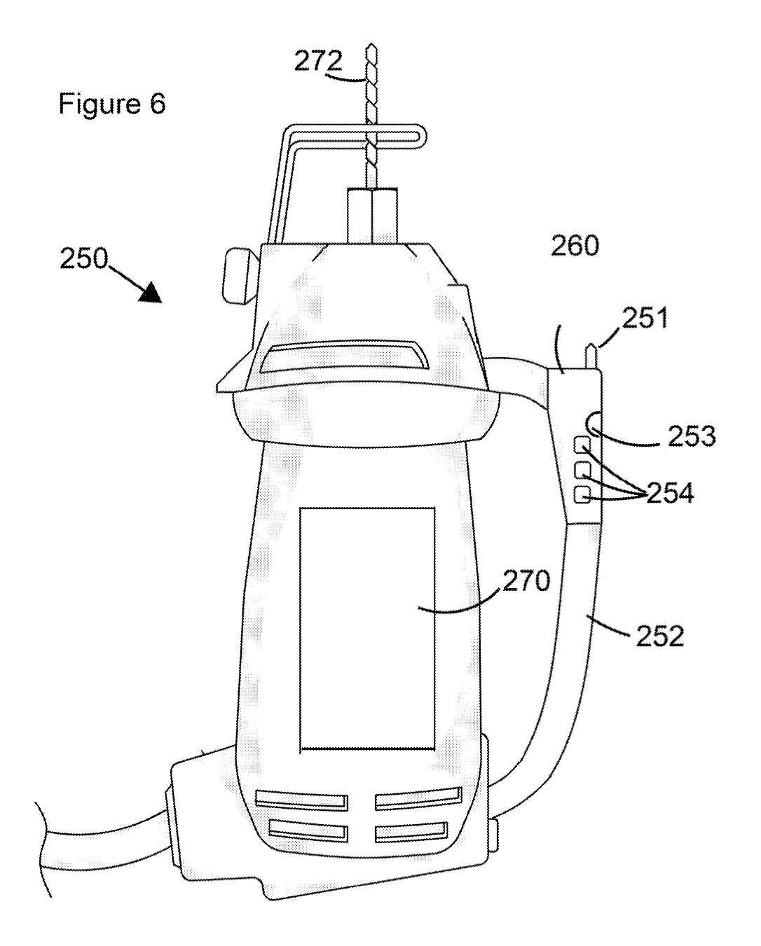

The router 250 located in FIG. 6 has the sensor/marking unit 260 on the handle 252. The hidden object would be located with the sensor 253 and then marked using marking unit 251. The handle 252 can include lights 254 to indicate the operation of the router 250, the sensor unit 260, and the combination of which are used for detecting hidden targets. The router 250 can further incorporate an LCD screen 270 in the body to indicate (graphically) a live image of the sought-after target (i.e. the light fixture, outlet box, etc) providing live feedback of the router bit's 272 location relative to the target. This can be accomplished through use of ultra sound, sonar, etc. to provide the feedback. Alternatively, RFID tags can be applied to the fixture at the time of installation and the feedback to the screen would be based upon data read by an RFID scanner. This would enable the operator to pinpoint exactly where to penetrate the sheet material relative to the position of the target behind the sheet material. The protrusion on the sensor/handle would permit the user to mark the routing location after determining the same.

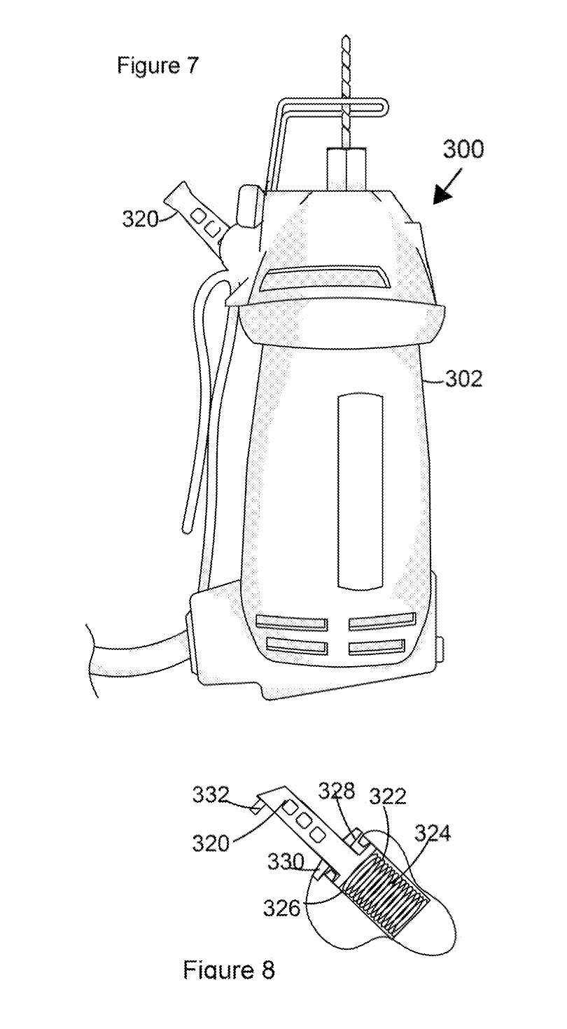

In FIGS. 7 and 8 the sensor unit 320 telescopes into a cavity 322 within the router body 302. The cavity 322 is preferably dimensioned to maintain a portion of the sensor unit 320 exposed to enable the sensor unit 320 to be pulled out. Alternatively the cavity 322 can contain a spring 324 to push the sensor unit 320 up above the body 302 of the router 300. In the example illustrated herein the sensor unit 320 has a flange, or flanges, 326 that prevent the sensor unit 320 from sliding out of the cavity 322 by interacting with ridge 328. A slide lock 330 interacts with locking flange 332 to maintain the sensor unit 320 recessed during non-use. Once the slide lock is removed from the opening of the cavity 322, the spring 324 pushes the sensor unit 320 out. This is an example only and there are other means for retaining a telescoping unit in a recessed or extended position and are known to those skilled in the art.

In an alternate embodiment to this and other designs, multiple sensors can be contained within a sensing unit or multiple sensing units containing one or more sensors can be used and positioned to sense objects at different planes to the sensor body. For example, a first sensor unit at the top can be positioned to be used to locate light fixtures in the ceiling while a second sensor unit on the side can be positioned to be used to locate wall outlets.

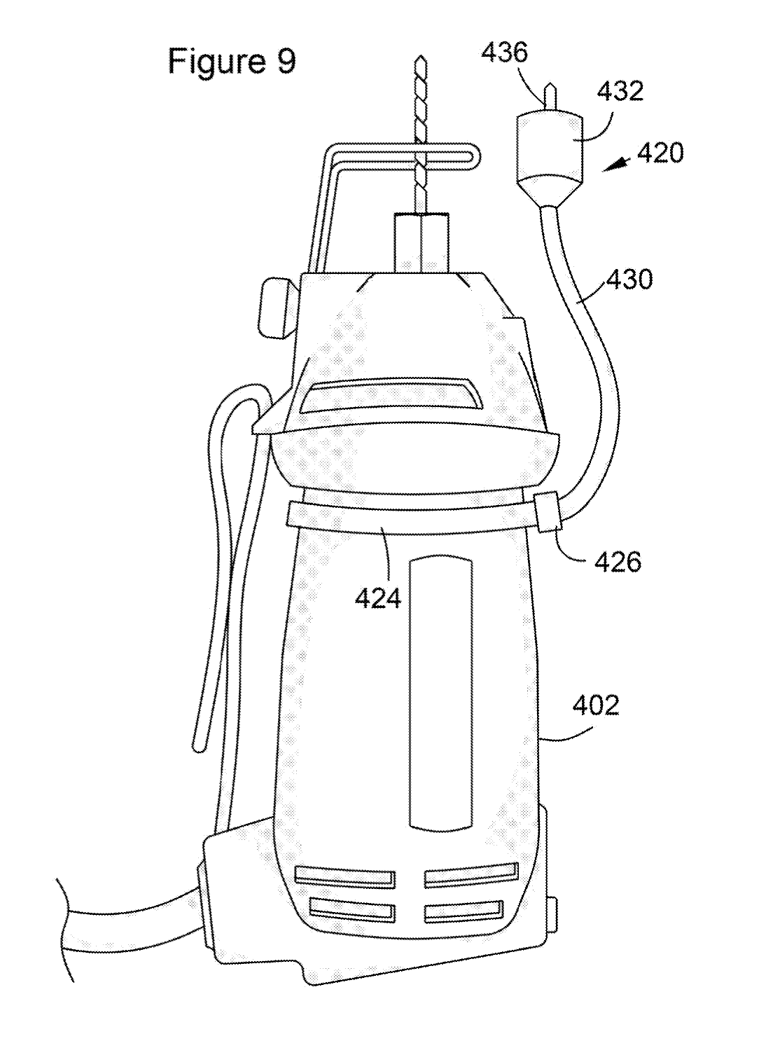

The integral sensor unit 420 of FIG. 9 is attached to a rail 424 through use of slide 426. The use of the slide 426 and rail 424 enable the sensor unit 420 to be positioned at any location around the circumference of the router body 402. Power to the sensor unit 420 is through energizing the rail 424, internal batteries, or separate plug in lead that is plugged either directly into the router body or to an outside electrical source. In the embodiment, the flexible arm 430 enables the sensor unit head 432 to be positioned facing in the optimal direction. It should be noted, however, that the rail 424 and slide 426 can be used with any sensor unit disclosed herein. The sensor unit 420 in this embodiment also incorporates an optional marking device 436. The marking device 436 can be any device that will place a mark on the material being marked and can include a scribe, pencil, ink, etc. and can be used on any embodiment disclosed herein. As the arm 430 is flexible, the marking device 436 must be of the type that can make a mark without the exertion of sufficient pressure to move the arm 430.

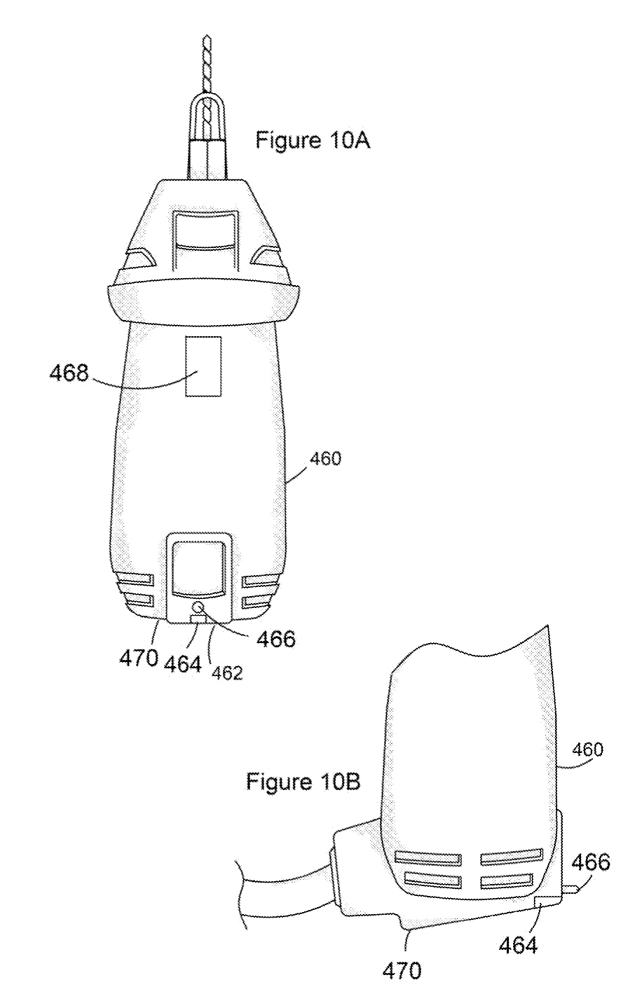

In FIGS. 10A and 10B the sensor/marker unit 462 has been partially recessed into the base 470 of the body 460 with the sensor 464 being located at the flat base 470 and the marking end 466 extending from the base. In this embodiment the user can rotate the router body 460, placing the base 470 to locate and mark the position of the blind object being sought behind the drywall or other sheet material. Once located, the router 460 is tilted to bring the marking end 466 into contact with the sheet material. Although the sensor/marker unit 462 is illustrated herein as being on the base 470, necessitating a 180 degree rotation for routing, the sensor/marker unit can also extend along the side of the body, requiring just a 90 degree rotation. The trigger 468 is positioned above the sensor/marker unit 462 in this embodiment, however the trigger 468 can be positioned at any location on the router that is convenient for use and manufacture

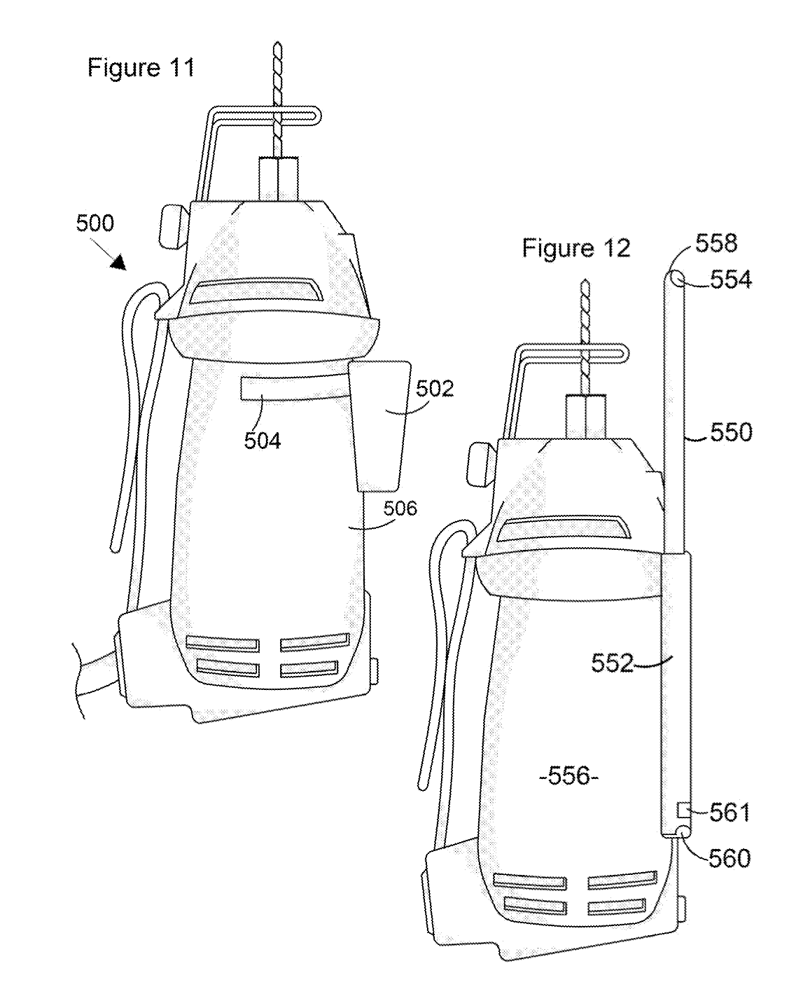

In the embodiment illustrated in FIG. 11, the sensor unit 502 requires no structural changes to the tool and is therefore applicable for use on existing cutting tools 500. The sensor unit 502 is affixed to a snap-on band 504 that enables the sensor unit 502 and band 504 to be removed from the router body 506. Alternatively the sensor unit 502 could be affixed to a hook and loop band, cinching, or other type band or securing device that is affixed to the router body. Not only does this embodiment enable the sensor unit 502 to be used with existing tools, it further enables the sensor unit 502 to move around the tool body 506 to the optimal position. It should be noted that any of the sensor unit configurations can be used with the band 504. A battery pack in either the body of the sensor unit or on the band must be incorporated when using any of the removable embodiments. Power could also be through a separate electrical connection that is connected directly to a “powered jack” or power socket in the router body 506 or other electrical source.

The embodiment illustrated in FIG. 11 does not have a marker, however, as with all embodiments, the marker can be added or removed depending upon manufacturing decisions.

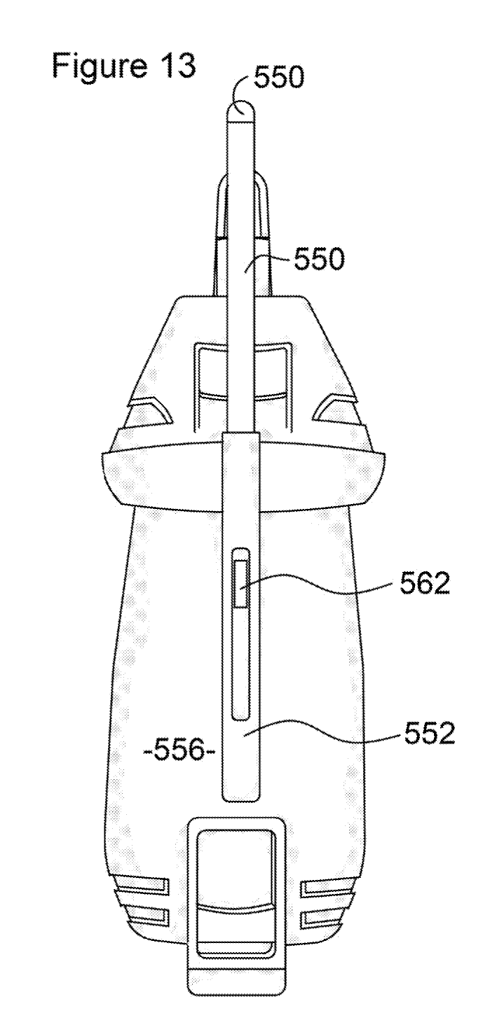

The router of FIGS. 12 and 13 incorporates a sensing/marking unit 550 that extends, through the use of a slide 562, release button, etc., similar to the release of a box cutter's blade. The sensor/marking unit 550 is equipped with a marking end 558 and sensor 554, slides down the enclosed track 552 within or on the router body 556. With the push of a thumb, the sensing/marking unit 550 will extend just beyond the tip of the router bit and lock in position, activating the sensing/marking unit 550 through use of a pressure switch or other means known in the art. Once the light fixture, outlet box, etc. has been detected as shown by light indicator 560 and audio indicator 561, a mark is made by pushing against the cover material with marking end 558. After marking, the sensing/marking unit 550 is retracted to its home position, de-activating the sensing unit 550. Light indicator 560 and audio indicator 561 can be incorporated into any of the embodiments disclosed herein. The dimensions of the sensor/marker must be sufficient to carry the required hardware as well as retain stability of the marking unit and the exact dimensions will be easily determined by those skilled in the art. Although the marking/sensor unit 550 is illustrated moving within the enclosed track 552, it should be noted that it can also slide along an open track.

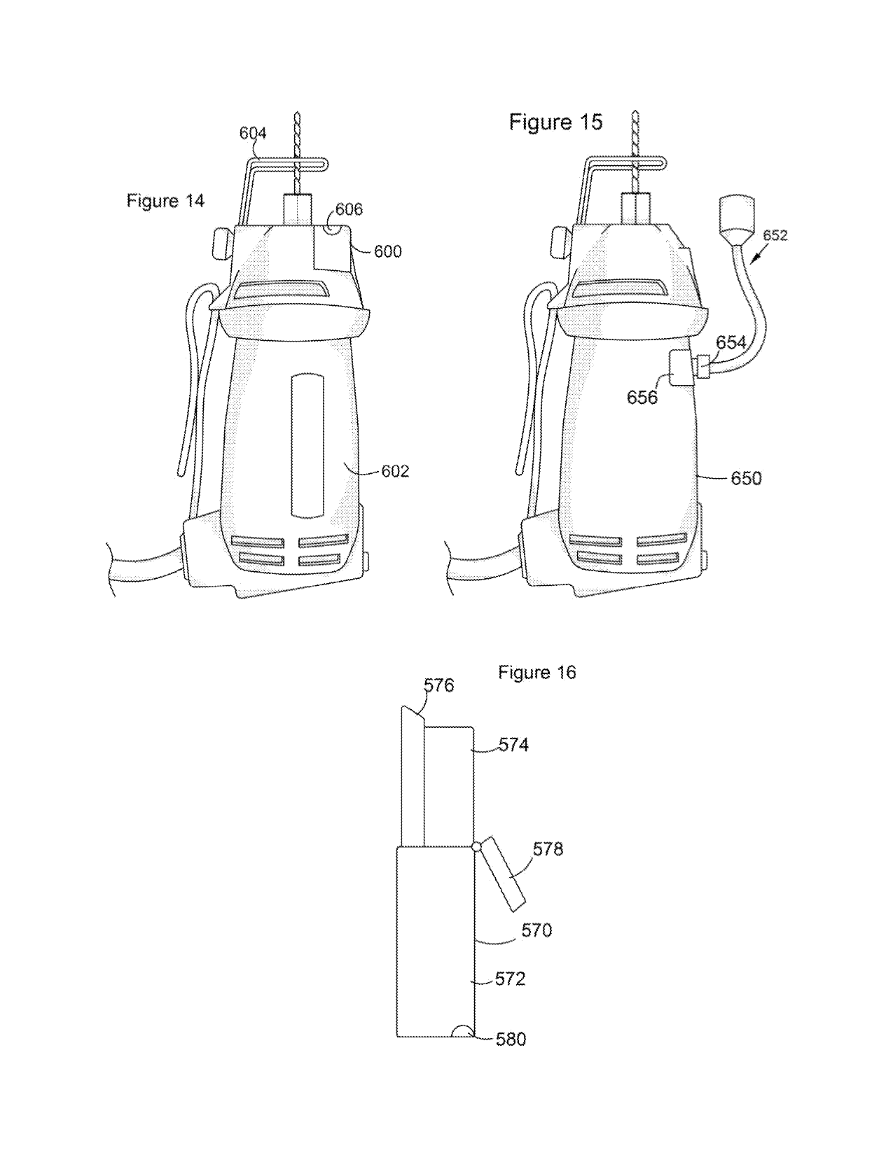

In FIG. 14 the sensor unit 600 has been recessed into the top of the router body 602. In this embodiment the detector signal is required to be of sufficient strength and focused direction to bypass the router body, travel a few inches to the drywall, penetrate the sheetrock and detect the light fixture/outlet box behind it. Although the sensor unit 600 could be positioned on the other side of the router, it would require a highly focused beam to avoid the supports 604.

In FIG. 15 the sensor unit 652 has a plug 654 that is placed in receiving jack or socket 656 that is wired directly into the electrical system of the router body 650. This enables the sensor unit 652 to be removed when not in use. It should be noted that where a sensor unit is on a flexible arm it can be interchanged with a fixed rigid sensor unit and vice versa.

In FIG. 16 an alternate sensing/marking device 570 is disclosed for use with the slide 552 of FIG. 12. The sensor unit 574 and marking device 576 slide down into the body 572 of the unit 570. At the time of marking, the sensor unit 574 and marking device 576 would be slid upward, out of the body 572 and, as the sensor unit 574 indicated the presence of a material behind the covering surface, the location is marked with the marking device 576. Once complete, the marking device 576 and sensor unit 574 are slid back into the body 572. Optimally there would be a cap 578 that would be placed over the sensor unit 574 and marking device 576 to prevent debris from hindering the functionality.

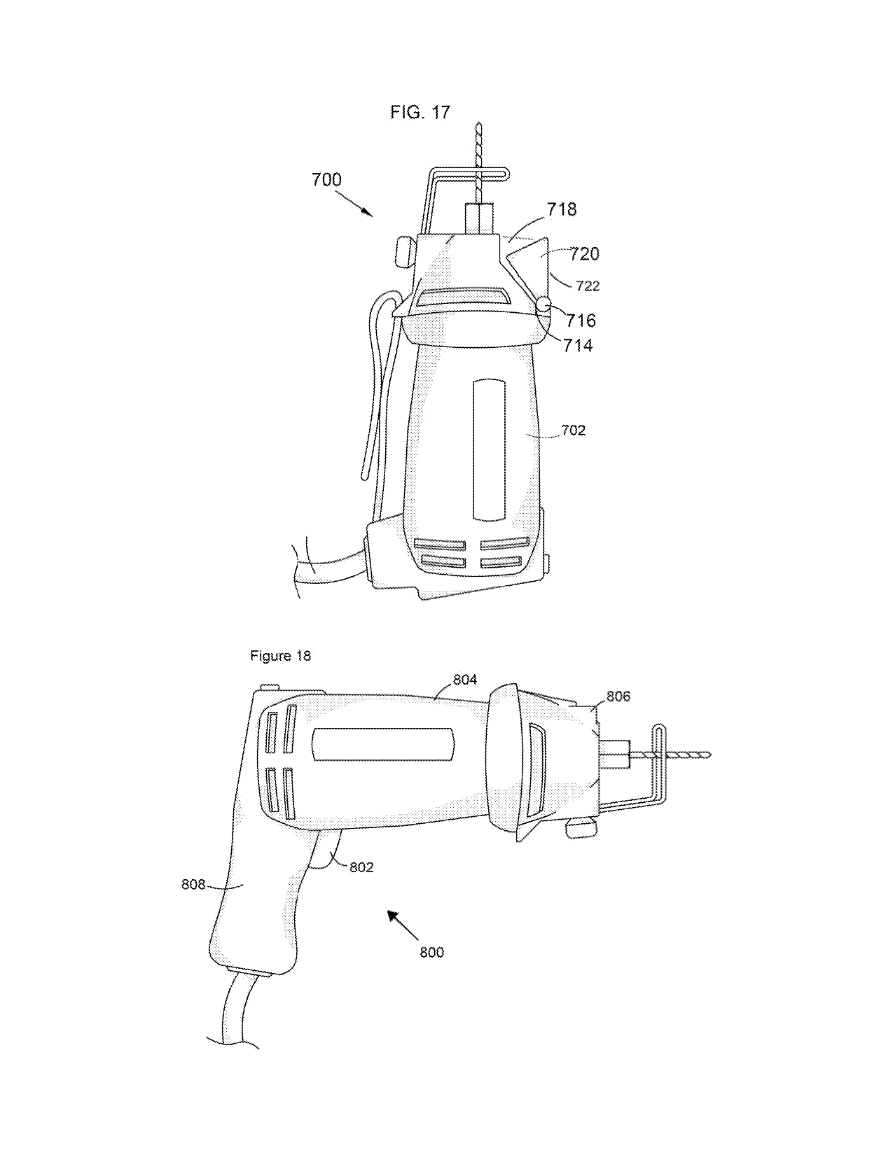

In FIG. 17 the body 702 of the router 700 had been manufactured with a cavity 718 to receive the sensor unit 720. The cavity 718 must be of sufficient size to retain at least a majority of body of the sensor unit 720 and can be of any convenient configuration. The sensor unit 720 can rotate at pivot point 716 and be connected directly into the power source of the router 700 through wiring 714. The sensor unit 720 can be retained in the open and closed positions in a number of ways known in the art, such as magnets, springs and snap locks. Alternatively the sensing unit 720 can be affixed in the open position.

The sensor unit 720 can employ the standard stud finder technology as the surface 722 can, when opened to a predetermined position, contact the sheet material. Additionally, the sensor 720 can be equipped with sensing technology such as found in metal detectors, thereby enabling the beam to be parallel with the cutting bit or blade as seen in FIG. 14.

In FIG. 18 a pistol grip handle 808 extends at an angle from the router body 804 with the cord, or in alternate embodiments a battery pack, on the non-operational end. The trigger 802 can be multi-stage or a single on/off with separate controls used to activate the sensor 806. In this embodiment the sensor/marking device 806 is a single unit, however any of the disclosed sensor or sensor/marking combinations can be incorporated on this, and any other, embodiment.

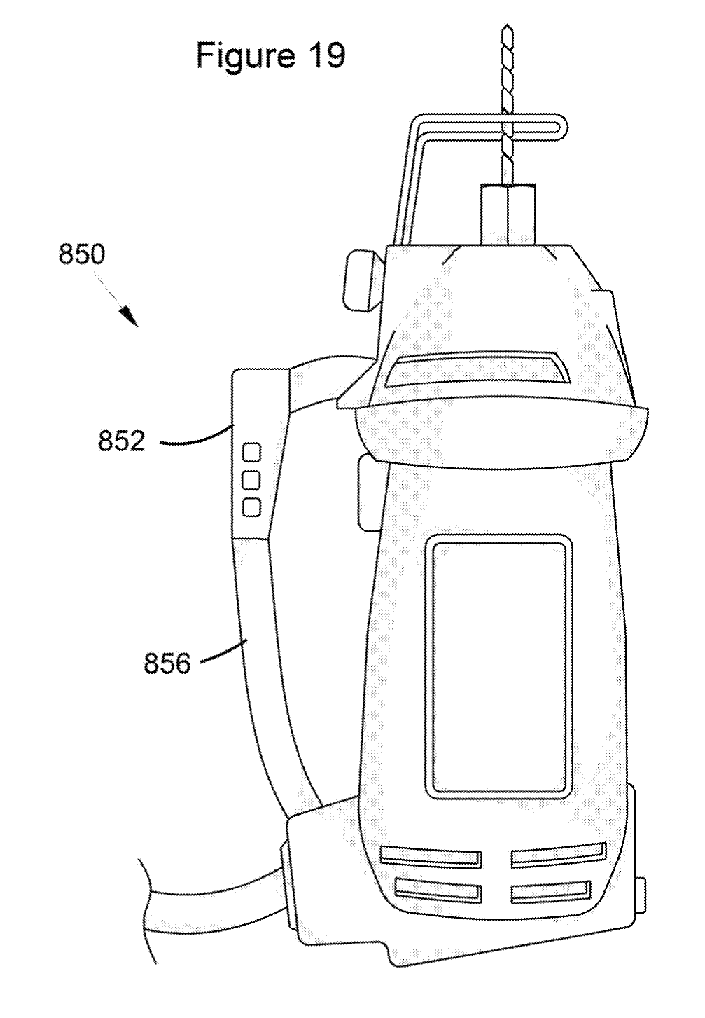

In FIG. 19 the router 850 is similar to that illustrated in FIG. 6, however the handle 856 is on the opposite side and the sensor unit 852 does not have a marking device. As noted heretofore, any feature described on another embodiment can be used on any of the disclosed embodiments and therefore the marking device could readily be added to this Figure.

It should be noted that while the drawings illustrate a single sensor per location, multiple sensors and multiple locations can also be incorporated.

It is advantageous in any of the foregoing embodiments to have a sensor with an adjustable depth-sensing mechanism through the use of a multi-position switch, toggle switch, thumb wheel switch or other types of switches currently available. The adjustable depth preferably includes the ability to set ranges and types of materials. This will enable a specific object with a known depth behind the sheet material to be detected but prevent sensing of irrelevant objects at a depth either deeper or shallower than that of the tool's setting. For example, only objects that are located between 1 and 4 inches behind the covering sheet material will be detected. The ability to ignore objects not within the designed depth or type of material enables the detector to more accurately locate the items to be approached or avoided. Although the majority of the time the fixtures and other materials at a shallower distance than the object to be located should be avoided, there are times such as when foil covered insulation has been applied, that this setting would be advantageous. The detector can also be manufactured to detect all objects that are at a maximum depth, thereby cutting the cost of the detector. The increments of the ranges would vary depending upon the cost, size, etc. and will be dependent upon manufacturer. Although any of the foregoing embodiments can be used with the variable detector, those embodiments having the ability for the sensor to be close up and touching the sheet material, would produce the greatest reliability with the least cost and energy use. As known in the art, the sensor needs to receive a baseline reading from the covering surface with no hidden object behind and then slid across the covering surface until alerted with the discovered target, at which point one uses the marking end to push and mark the spot.

It should be noted that any of the sensors herein can incorporate a light beam or laser to provide a visual component, as well as an audio one, to confirm and/or indicate the location where the sensing beam is striking. Also, it should be noted that where a sensor is on a flexible arm it can be interchanged with a fixed rigid sensor and vice versa. Additionally, a marking device can be included on any of the foregoing embodiments.

Although a single sensor has been described heretofore, multiple sensors, placed in the disclosed manner, can also be incorporated.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language of the present invention or inventions should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A powered cutting tool having:
a body, said body containing a cutting element, a motor, a power source, an on/off trigger, a front, a back, and a base,
at least one sensor, a transceiver having a transmitted signal, said transmitted signal detecting at least one from the group of object density, conductivity, depth, identification,
at least one sensor unit, each of said at least one sensor unit receiving power from a power source and each of said at least sensor unit containing at least one of said at least one sensor and having flat outer surface, at least two sides, a top and a bottom forming an inner periphery conforming to said body.

2. The cutting tool of claim 1 wherein said at least one sensor unit is integral with said body along at least a portion of said inner periphery.

3. The cutting tool of claim 2 wherein at least one of said at least one sensor unit is located at said front of said tool.

4. The cutting tool of claim 3 wherein said at least one sensor unit is proximate said cutting element.

5. The cutting tool of claim 3 wherein said at least one sensor unit is proximate said base.

6. The cutting tool of claim 1 wherein said power source for said sensor unit is from said cutting tool power source.

7. The cutting tool of claim 1 further comprising at least one marking unit, said marking unit being positioned to contact sheet material without interference from said body.

8. The cutting tool of claim 7 wherein said at least one marking unit is integral with at least one of said at least one sensor unit and positioned to enable said sensor unit to lie flush with the sheet material.

9. The cutting tool of claim 1 further comprising at least one indicator member.

10. The cutting tool of claim 9 wherein at least one of said at least one said indicator member is visual.

11. The cutting tool of claim 9 wherein at least one of said at least one indicator member is audio.

12. The cutting tool of claim 1 further comprising a screen, said screen to display images and data received from each said at least one sensor.

13. The cutting tool of claim 1 wherein said power source is AC.

14. The cutting tool of claim 1 wherein said power source is DC.

15. The cutting tool of claim 1 wherein said cutting tool is a spiral saw.

16. The cutting tool of claim 1 wherein said transmitted signal of each of said at least one sensor has an adjustable signal strength.

17. The cutting tool of claim 16 wherein further comprising a handle, said handle having a trigger and said strength of said transmitted signal of each of said at least one sensor is adjustable through said trigger or through separate mechanism on said cutting tool.

18. The cutting tool of claim 1 wherein said sensor unit power is obtained from said cutting tool power source.

19. The cutting tool of claim 1 wherein said sensor unit further comprises a attachment member, said attachment member being dimensioned to removably affix said sensor unit and said sensor power source to said body.

20. A powered cutting tool having
a body, said body containing a cutting element, a motor, a power source, an on/off trigger, a front and a back, and a base,
at least one sensor, each of said at least one sensor receiving power from a power source and having a transceiver having a transmitted signal, said transmitted signal detecting at least one from the group of object density, conductivity, depth, identification,
at least one sensor unit affixed to said body, each of said at least sensor unit containing:
at least one of said at least one sensor and
a housing, said housing having a flat outer surface, at least two sides, a top and a bottom forming an inner periphery conforming to said body,
at least one marking unit, said marking unit being integral with at least one of said at least one sensor unit, said marking unit having means for applying a visual or palpable mark on a sheet material.
at least one indicator means, at least one of said at least one indicator means being from group consisting of indicator lights, audio, and display screen.

21. A spiral saw having:
a body, said body containing a cutting element, a motor, a power source, an on/off trigger, a front and a back, and a base,
at least one sensor, each of said at least one sensor receiving power from a power source and having a transceiver having a transmitted signal, said transmitted signal detecting at least one from the group of object density, conductivity, depth, identification,
at least one sensor unit affixed to said body, each of said at least sensor unit containing:
at least one of said at least one sensor and
a housing, said housing having a flat outer surface, at least two sides, a top and a bottom forming an inner periphery conforming to said body, at least one marking unit, said marking unit being integral with at least one of said at least one sensor unit,
a power source
at least one indicator means, at least one of said at least one indicator means being from group consisting of indicator lights, audio, and display screen.
